(19) United States
(12) Patent Application Publication
(10) Pub. No.: US 2014/0265085 A1
(43) Pub. Date: Sep. 18, 2014

(54) ADJUSTABLE TOGGLE ACTION QUICK RELEASE LOCKING BAR CLAMP

(71) Applicant: Stephen D. ALBIN, Los Altos, CA (US)

(72) Inventor: Stephen D. ALBIN, Los Altos, CA (US)

(21) Appl. No.: 14/206,980

(22) Filed: Mar. 12, 2014

Related U.S. Application Data
(60) Provisional application No. 61/800,477, filed on Mar. 15, 2013.

(51) Int. Cl. B25B 5/12; B25B 5/16

(52) U.S. Cl. CPC B25B 5/127; B25B 5/163
USPC 269/6; 269/257

(57) ABSTRACT

A bar clamp having a locking pliers, toggle action clamping mechanism is herein disclosed. The locking pliers include a fixed handle, a movable handle, and a toggling linkage arrangement therebetween for toggling the locking pliers from a first open position to a second clamped position. A bar is connected at one end to the fixed handle. The bar clamp includes an adjustable outer clamping jaw slidably connected to the bar. The outer clamping jaw includes disengageable locking mechanism for disengagably locking the outer clamping jaw in any given position along the length of the bar. The bar clamp also includes an inner clamping jaw connected to the toggling linkage arrangement such that when the locking pliers are toggled into the clamped position the inner clamping jaw is caused to move toward the adjustable outer clamping jaw.

### CROSS-REFERENCE TO RELATED APPLICATIONS

This application claims benefit to U.S. Provisional Patent Application No. 61/800,477 filed on Mar. 15, 2013, entitled “ADJUSTABLE TOGGLE ACTION QUICK RELEASE LOCKING BAR CLAMP,” which is incorporated herein by reference for all purposes. Additionally, this application is related to U.S. Provisional Patent Application No. 289,931 filed Aug. 12, 1994 and issued as U.S. Pat. No. 5,499,800 on Mar. 19, 1996, entitled “ADJUSTABLE TOGGLE ACTION QUICK RELEASE LOCKING BAR CLAMP,” which is incorporated herein by reference for all purposes.

### BACKGROUND OF THE INVENTION

1. Field of the Invention

The present invention relates generally to toggle action hand tools, and more specifically to a locking bar clamp with a locking pliers type, toggle action clamping mechanism.

2. Background

Locking pliers type hand tools with toggle action clamping mechanisms are generally known as locking pliers or vice clamps. These conventional tools usually include a fixed handle having a fixed jaw extending from one end of the fixed handle, a movable handle, and a toggling linkage arrangement interconnecting the fixed handle and the movable handle. The toggling arrangement typically includes a movable jaw extending from the toggling linkage arrangement in such a way that when the locking pliers are toggled from a first open position to a second toggled position the movable jaw is moved toward the fixed jaw.

Since the original development of the locking pliers a wide variety of jaw arrangements have been developed for all types of applications. For example, U.S. Pat. No. 4,850,254 describes a locking hand tool including locking pliers in which a user adjustable jaw and a movable jaw are moved toward one another in a direction generally perpendicular to the handles of the locking pliers when the locking pliers are toggled into the locked or toggled position. This arrangement provides an adjustable clamp in which the locking pliers extend perpendicular to the direction of clamping action. Although this a useful arrangement in some situations, there are many situations in which the generally perpendicular location of the locking pliers interferes with the work being performed. The present invention discloses a toggle action quick release bar clamp having a specific jaw arrangement for toggle action locking pliers which provides a bar clamp with a clamping action direction that is along the longitudinal axis of the locking pliers handle or parallel with the handle.

### SUMMARY OF THE INVENTION

As will be described in more detail hereinafter, a locking bar clamp having a locking pliers, toggle action clamping mechanism is disclosed. The locking pliers include a fixed handle, a movable handle, and toggling linkage mechanism extending there between for toggling the locking pliers from a first open position to a second clamped position. A bar is connected to the fixed handle. An adjustable outer clamping jaw is slidably connected to the bar. The outer clamping jaw includes a disengageable locking mechanism for disengagably locking the outer clamping jaw at any given position along the length of the bar. The bar clamp also includes an inner clamping jaw connected to the toggling linkage mechanism such that when the locking pliers are toggled into the clamped position, the inner clamping jaw is caused to move toward the adjustable outer clamping jaw.

These and other features of the present invention will be described in more details below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a diagrammatic side view of a first embodiment of an adjustable toggle action quick release bar clamp designed in accordance with embodiments of the present invention;

FIG. 1B is a diagrammatic side view of the outer clamping jaw shown in FIG. 1A in accordance with embodiments of the present invention;

FIG. 1C is a diagrammatic side view of a second embodiment of an adjustable toggle action quick release bar clamp designed in accordance with embodiments of the present invention;

FIGS. 1D-1H illustrate views of the jaw arrangement as shown in FIGS. 1A and 1C in accordance with embodiments of the present invention;

FIG. 1I illustrates a view of a base component that is described in FIGS. 1A and 1C in accordance with embodiments of the present invention;

FIG. 2 illustrates a view of clutch plate in accordance with embodiments of the present invention;

FIGS. 3A and 3B illustrate dimensions of inner clamping jaw having a cover pad in accordance with embodiments of the present invention;

FIGS. 4A and 4B illustrate dimensions of inner clamping jaw without a cover pad in accordance with embodiments of the present invention;

FIG. 5A is a diagrammatic side view of a third embodiment of an adjustable toggle action quick release bar clamp designed in accordance with embodiments of the present invention;

FIG. 5B illustrates a view of a clutch plate in accordance with embodiments of the present invention;

FIG. 5C is a diagrammatic side view of a fourth embodiment of an adjustable toggle action quick release bar clamp designed in accordance with embodiments of the present invention;

FIG. 6A provides a top view of the bar as shown in FIGS. 5A and 5C in accordance with embodiments of the present invention;

FIG. 6B provides a side view of the bar as shown in FIGS. 5A and 5C in accordance with embodiments of the present invention.

### DETAILED DESCRIPTION OF THE PREFERRED EMBODIMENTS

The present disclosure will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Referring initially to FIG. 1A, a first preferred embodiment of an adjustable toggle action quick release bar clamp designed in accordance with the present invention and generally designated by reference numeral 10 is illustrated. As will be described in more detail hereinafter, bar clamp 10 includes a conventional locking pliers toggle action clamping mechanism generally designated by reference numeral 12, an bar extending from locking pliers 12 generally designated by reference numeral 14, and a slidable outer jaw arrangement generally designated by reference numeral 16.

Still referring to FIG. 1A the conventional locking pliers 12 will now be described in detail. Locking pliers of this type typically include a fixed handle 18 having a first end 20 and a second end 22, a movable handle 24 also having a first end 26 and a second end 28, and a toggling linkage arrangement generally designated by reference numeral 30 interconnecting fixed handle 18 and movable handle 24. In the particular locking pliers illustrated, the toggling linkage arrangement includes a first toggling lever 32 and a second toggling lever 34. The first toggling lever 32 is pivotally connected at point 36 to the first end 20 of fixed handle 18 and pivotally connected at point 38 to the first end 26 of movable handle 24. Fixed handle 18 is formed having a channel 40 along its length and an adjusting screw 42 threaded into its second end 22. The second toggling lever 34 has a first end pivotally connected at point 44 near the mid point of movable handle 24 and its other end indicated at point 46 is positioned within channel 40 of fixed handle 18 connected to adjusting screw 42. Toggling linkage arrangement 30 also includes a spring 48 attached at one end to a mid point 50 of toggling lever 32 and attached at its other end to a mid point (not shown) of fixed handle 18. This toggling linkage arrangement allows the locking pliers to be toggled between a first open position and a second locked or clamped position.

When locking pliers 12 are moved from the open position to the clamped position, movable handle 24 drives against toggling lever 32 at pivot point 38. Movable handle 24 is forced against toggling lever 32 by toggling lever 34 at pivot point 44. And finally toggling lever 34 is forced against movable handle 24 by the end of adjusting screw 42 at point 46. Therefore, movable handle 24 forces toggling lever 32 to pivot about point 36 on fixed handle 18 such that toggling lever 32 moves generally along the longitudinal axis of fixed handle 18 in the direction away from adjusting screw 42. In a presently preferred embodiment of the present invention, an inner clamping jaw 43 is pivotally connected to toggling lever 32. It should be appreciated that, the toggling lever 32 may also be formed as an integrated part of the clamping jaw. Therefore, as the locking pliers are moved from the open position to the clamped position, inner clamping jaw 43 is also moved generally along the longitudinal axis of fixed handle 18 in the direction away from adjusting screw 42. Furthermore, adjusting screw 42 gives the user of the tool an infinitesimal control over the relative position of the inner clamping jaw 43 relative to fixed handle 18 along the longitudinal axis of the tool within a certain range.

When in the open position and when viewed as shown in FIG. 1A, point 44 on movable handle 24 is out of line with and below the line formed by point 38 on movable handle 24 and point 46 at the end of adjusting screw 42. However, when the locking pliers are moved into the clamped position, point 44 on movable handle 24 is rotated about point 38 on movable handle 24 between points 38 and 46 to a position above the line formed by points 38 and 46. This moving of point 44 from below the line between points 38 and 46 causes the toggling or locking action of the locking pliers. The specific locking pliers shown in FIG. 1A also includes a quick release lever 53 which, when the locking pliers are in the clamped position, engages toggling lever 34. This quick release lever allows the user to quickly move the locking pliers from the clamped position to the open position by forcing movable handle downward as viewed in FIG. 1A such that point 44 is rotated around point 38 to a position below the line between points 38 and 46.

Although FIG. 1A shows locking pliers as described immediately above, it should be understood that the present invention is not limited to using this specific locking pliers arrangement but instead would apply to any conventional toggle action locking pliers clamping mechanism regardless of its specific toggling arrangement. Still referring to FIG. 1A, bar arrangement 14 will now be described in detail. In a presently preferred embodiment of the present invention, bar 14 has a circular cross section and is attached to base component 21. In the presently preferred embodiment, bar 14 is connected to the fixed handle 18 of the locking pliers 12 using threaded ends. End 20 of fixed handle 18 of the locking pliers includes an externally threaded protrusion 60 for receiving the internally threaded end 56 of one of bar 14.

Also, in accordance with the present invention, bar arrangement 14 is attached to locking pliers 12 such that the longitudinal axis of the bar arrangement is substantially in line with or at least substantially parallel with the longitudinal axis of the fixed handle 18 of locking pliers 12. This specific orientation of the bar arrangement 14 positions the slidable outer clamping jaw arrangement 16 in the proper position such that when the locking pliers are moved from the open position to the clamped position, as described in detail above, inner clamping jaw 43 is forced along the longitudinal axis of the tool toward outer clamping jaw arrangement 16 providing an adjustable clamping arrangement. Furthermore, since the bar 14 is attached to the fixed handle 18 of the locking pliers, adjusting screw 42 gives the user of the tool an infinitesimal control over the relative position of the inner clamping jaw 43 relative to the slidable outer clamping jaw 16 along the longitudinal axis of the tool within a certain range for any given positioning of the outer jaw.

Although bar 14 has been described as having a circular cross section, it should be understood that the present invention is not limited to a bar with a circular cross section, but instead would apply to a bar of any cross section such as square, rectangular, oval. or I-beam shaped. Also, even though the bar has been described as being detachable, these features are not required to be included in the present invention. For instance, bar 14 may be permanently fixed to the locking pliers with or without removable sections or may be detachably attached to the locking pliers by an arrangement other than the threaded arrangement described. It should be understood that the present invention would equally apply to these other arrangements.

Referring now to FIG. 1B, the outer clamping jaw arrangement 16 will be described in detail. In a preferred embodiment of the present invention, outer clamping jaw arrangement 16 includes a portion having a circular cross sectional opening 62 through which the arrangement is slidably connected to bar 14. Outer clamping jaw arrangement 16 also includes a portion having a slot 64 for receiving a locking clutch 66 pivotal mounted to jaw arrangement 16 such that locking clutch 66 may engage bar 14 when jaw arrangement 16 is slidably attached to the bar. A spring 68 biases locking clutch 66 to engage bar 14 and locking clutch 66 is positioned such that when pressure is exerted on jaw arrangement 16 in the direction away from the locking pliers, locking clutch 66 prevents jaw arrangement 16 from sliding along bar 14. However, this arrangement allows the user to slide jaw arrangement 16 toward the locking pliers without disengaging locking clutch 66. Additionally, locking clutch 66 may also be used as a lever that is designed to allow the user of the tool to disengage locking clutch 66 allowing the outer clamping jaw arrangement 16 to slide freely along bar 14. Jaw arrangement 16 also includes an outer clamping pad 72 extending from the side of jaw arrangement 16 opposite locking clutch 66.

With the immediately above described arrangement for outer clamping jaw arrangement 16, this arrangement may be rotated about the longitudinal axis of bar 14. This allows the user of the tool to position outer clamping pad 72 out of line with inner clamping jaw 43. This may be particularly important in situations where an irregular shaped piece is being clamped and there is not an adequate surface for outer clamping pad 72 to bear on when the inner and outer jaws are in line with one another.

Although only one specific arrangement for outer clamping jaw arrangement has been described, it should be understood that this arrangement may take many forms. For instance, if the cross sectional shape of bar 14 is something other than circular, opening 62 may be made to match the other cross sectional shape. Also, it should be understood that other locking mechanisms may be used such as set screws, locking levers, or any other conventional arrangement for locking a movable jaw in place.

FIG. 1C is a diagrammatic side view of a second embodiment of an adjustable toggle action quick release bar clamp designed in accordance with the present invention. In particular, FIG. 1C matches FIG. 1A with the addition of bar 15 and two prying holes 62 and 64 In particular, prying holes 62 and 64 may be used to pry open bar 14 and 15 when they are screwed together. In particular, bar 14 and bar 15 may be joined together through the use of screws, as discussed in embodiments of U.S. Pat. No. 5,499,800 as referenced herein. If bar 14 and bar 15 are joined too tightly, then they may be loosened by inserting two levers and then pressing against the thread so as to open the bars 14 and 15.

FIGS. 1D-1H also provide images of jaw arrangement 16 in accordance with embodiments of the present invention. In particular, FIG. 1D illustrates dimensions of a top view of jaw arrangement 16; FIG. 1E illustrates dimensions of a first side view of jaw arrangement 16; FIG. 1F illustrates dimensions of a bottom view of jaw arrangement 16; FIG. 1G illustrates dimensions of a front view of jaw arrangement 16; and FIG. 1H illustrates dimensions of a second side view of jaw arrangement 16.

Additionally, FIG. 1I provides an additional view of a base component that is described in FIGS. 1A and 1C as base component 21.

Further, FIG. 2 illustrates a view of clutch plate 67. In particular, clutch plate 67 is a component of locking clutch 66. While FIG. 1A illustrates locking clutch 66 as comprising one clutch plate 67, alternative embodiments of locking clutch 66 may comprise additional clutch plates stacked in a row. In particular, when locking clutch 66 includes more than one clutch plate, additional pressure is applied to bar 14, securing jaw arrangement 16.

Additionally, FIGS. 3A and 3B illustrate dimensions of inner clamping jaw 43 having a cover pad in accordance with embodiments of the present invention. In particular, FIG. 3A provides a front view 300 of inner clamping jaw 43 having a cover pad and FIG. 3B provides a side view 350 of inner clamping jaw 43 having a cover pad. Further, outer clamping pad 72 may be similar to inner clamping jaw 43.

Also, FIGS. 4A and 4B illustrate dimensions of inner clamping jaw 43 without a cover pad in accordance with embodiments of the present invention. In particular, FIG. 4A provides a front view 400 of inner clamping jaw 43 without a cover pad and FIG. 4B provides a side view 450 of inner clamping jaw 43 having a cover pad. Further, outer clamping pad 72 may be similar to inner clamping jaw 43.

Referring initially to FIG. 5A, a third embodiment of an adjustable toggle action quick release bar clamp designed in accordance with the present invention and generally designated by reference numeral 510 is illustrated. As will be described in more detail hereinafter, bar clamp 510 includes a conventional locking pliers toggle action clamping mechanism generally designated by reference numeral 512, an bar extending from locking pliers 512 generally designated by reference numeral 514, and a slidable outer jaw arrangement generally designated by reference numeral 516.

Still referring to FIG. 5A the conventional locking pliers 512 will now be described in detail. Locking pliers of this type typically include a fixed handle 518 having a first end 520 and a second end 522, a movable handle 24 also having a first end 526 and a second end 528, and a toggling linkage arrangement generally designated by reference numeral 530 interconnecting fixed handle 518 and movable handle 524. In the particular locking pliers illustrated, the toggling linkage arrangement includes a first toggling lever 532 and a second toggling lever 534. The first toggling lever 532 is pivotally connected at point 536 to the first end 520 of fixed handle 518 and pivotally connected at point 538 to the first end 526 of movable handle 524. Fixed handle 518 is formed having a channel 40 along its length and an adjusting screw 542 threaded into its second end 522. The second toggling lever 534 has a first end pivotally connected at point 544 near the mid point of movable handle 524 and its other end indicated at point 546 is positioned within channel 540 of fixed handle 518 connected to adjusting screw 542. Toggling linkage arrangement 530 also includes a spring 548 attached at one end to a mid point 550 of toggling lever 532 and attached at its other end to a mid point (not shown) of fixed handle 518. This toggling linkage arrangement allows the locking pliers to be toggled between a first open position and a second locked or clamped position.

When locking pliers 512 are moved from the open position to the clamped position, movable handle 524 drives against toggling lever 532 at pivot point 538. Movable handle 524 is forced against toggling lever 532 by toggling lever 534 at pivot point 544. And finally toggling lever 534 is forced against movable handle 524 by the end of adjusting screw 42 at point 546. Therefore, movable handle 524 forces toggling lever 532 to pivot about point 36 on fixed handle 518 such that toggling lever 532 moves generally along the longitudinal axis of fixed handle 518 in the direction away from adjusting screw 542. In a presently preferred embodiment of the present invention, an inner clamping jaw 543 is pivotally connected to toggling lever 532. It should be appreciated that, the toggling lever 532 may also be formed as an integrated part of the clamping jaw. Therefore, as the locking pliers are moved from the open position to the clamped position, inner clamping jaw 543 is also moved generally along the longitudinal axis of fixed handle 518 in the direction away from adjusting screw 542. Furthermore, adjusting screw 542 gives the user of the tool an infinitesimal control over the relative position of the inner clamping jaw 543 relative to fixed handle 518 along the longitudinal axis of the tool within a certain range.

When in the open position and when viewed as shown in FIG. 5A, point 544 on movable handle 524 is out of line with and below the line formed by point 538 on movable handle 524 and point 546 at the end of adjusting screw 542. However, when the locking pliers are moved into the clamped position, point 544 on movable handle 524 is rotated about point 538 on movable handle 524 between points 538 and 546 to a position above the line formed by points 538 and 546. This moving of point 544 from below the line between points 538 and 546 causes the toggling or locking action of the locking pliers. The specific locking pliers shown in FIG. 5A also includes a quick release lever 553 which, when the locking pliers are in the clamped position, engages toggling lever 534. This quick release lever allows the user to quickly move the locking pliers from the clamped position to the open position by forcing movable handle downward as viewed in FIG. 5A such that point 544 is rotated around point 538 to a position below the line between points 538 and 546.

In the presently preferred embodiment, bar 514 is within the same entity of fixed handle 518. Also, in accordance with the present invention, bar arrangement 514 is attached to locking pliers 512 such that the longitudinal axis of the bar arrangement is substantially in line with or at least substantially parallel with the longitudinal axis of the fixed handle 518 of locking pliers 512. This specific orientation of the bar arrangement 514 positions the slidable outer clamping jaw arrangement 516 in the proper position such that when the locking pliers are moved from the open position to the clamped position, as described in detail above, inner clamping jaw 543 is forced along the longitudinal axis of the tool toward outer clamping jaw arrangement 516 providing an adjustable clamping arrangement. Furthermore, since the bar 514 is attached to the fixed handle 518 of the locking pliers, adjusting screw 542 gives the user of the tool an infinitesimal control over the relative position of the inner clamping jaw 543 relative to the slidable outer clamping jaw 516 along the longitudinal axis of the tool within a certain range for any given positioning of the outer jaw.

FIG. 5B illustrates a view of clutch plate 567 in accordance with embodiments of the present invention. In particular, clutch plate 567 is a component of locking clutch 566. While FIG. 5A illustrates locking clutch 566 as comprising one clutch plate 567, alternative embodiments of locking clutch 66 may comprises additional clutch plates stacked in a row. In particular, when locking clutch 566 includes more than one clutch plate, additional pressure is applied to bar 514, securing jaw arrangement 516.

FIG. 5C is a diagrammatic side view of a fourth embodiment of an adjustable toggle action quick release bar clamp designed in accordance with the present invention. In particular, FIG. 5C matches FIG. 5A with the addition of stopper 555, hole 557, and front bar view 558. In particular, stopper 555 works to keep outer jaw 516 from being removed from rod 514. Further, hole 557 allows a user to hang the clamp shown in FIG. 5C from a hook. Additionally, front bar view 558 illustrates the dimensions of bar 514 when viewed from the front. As seen in FIG. 5C, bar 514 is a rod having a generally rectangular cross section having curved edges.

Additionally, FIGS. 6A and 6B provide an additional view of bar 514 that is described in FIGS. 6A and 6C. In particular, FIG. 6A provides a top view of bar 14 and FIG. 6B provides a side view of bar 14.

Although only a few embodiments of the present invention have been described in detail, it should be understood that the present invention may be embodied in many other specific forms without departing from the spirit or scope of the invention. As mentioned above, the bar may take on a wide variety of cross sectional shapes. It may be fixed to or detachable from the locking pliers and may be made up of a plurality of sections or one continuous bar. Also as mentioned above, the slidable outer jaw may take on a wide variety of specific shapes and incorporate a variety of locking arrangements for locking the outer jaw in place on the bar.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A locking bar clamp comprising:
a) a locking pliers mechanism including a fixed handle having a longitudinal axis, a movable handle, and a toggling linkage mechanism coupled between the fixed and moveable handles for toggling the locking pliers from a first open position to a second clamped position;
b) a bar having a longitudinal axis and including first and second ends, the first end being connected to and extending from the fixed handle of the locking pliers such that the longitudinal axis of the bar is substantially parallel with the longitudinal axis of the fixed handle of the locking pliers;
c) an adjustable outer clamping jaw slidably connected to the bar for longitudinal movement along the bar, the outer clamping jaw including a disengageable locking mechanism for disengagably locking the outer clamping jaw to the bar; and
d) an inner clamping jaw connected to the toggling mechanism such that when the locking pliers are toggled into the clamped position the inner clamping jaw is caused to move in a direction generally aligned with the longitudinal axis of the fixed handle of the locking pliers and the longitudinal axis of the bar toward the adjustable outer clamping jaw.

2. The locking bar clamp as set forth in claim 1 wherein the locking pliers mechanism includes adjusting means for adjusting the longitudinal position of the inner clamping jaw relative to the fixed handle of the locking pliers.

3. The locking bar clamp as set forth in claim 2 wherein:
the toggle linkage mechanism includes first and second linkages coupled between the fixed and moveable handles;
the fixed handle includes a channel; and
the adjusting means includes an adjusting screw threaded into the fixed handle for adjusting the position of a first end of the first linkage relative to the fixed handle, thereby adjusting the longitudinal position of the inner clamping jaw.

4. The locking bar clamp as set forth in claim 1 wherein the toggling linkage mechanism includes first and second linkages coupled between the fixed and moveable handles and a quick release lever and wherein the inner clamping jaw is pivotally connected to the second linkage.

5. The locking bar clamp as set forth in claim 1 wherein the bar is detachable from the fixed handle.

6. The locking bar clamp as set forth in claim 1 wherein the bar has a circular cross section.

7. The locking bar clamp as set forth in claim 6 wherein the bar includes a plurality of detachable bar sections allowing for a variety of bar lengths.

8. The locking bar clamp as set forth in claim 7 wherein the detachable bar sections include threaded ends for interconnecting the bar sections.

9. The locking bar clamp as set forth in claim 6 wherein the adjustable outer clamping jaw includes an portion having a circular cross sectional opening through which the outer clamping jaw is slidably connected to the bar.

10. The locking bar clamp as set forth in claim 9 wherein the adjustable outer clamping jaw may be rotated to various positions around the longitudinal axis of the bar allowing the outer clamping jaw to be positioned out of line with the inner clamping jaw.

11. The locking bar clamp as set forth in claim 1 wherein the disengageable locking mechanism for locking the outer clamping jaw in position includes (i) a locking clutch pivotally connected to the outer clamping jaw such that the locking clutch may engage the bar, (ii) a spring for biasing the locking clutch against the bar, and (iii) a lever extending from the locking clutch adapted to allow the user of the tool to disengage the locking clutch thereby allowing the outer clamping jaw to slide freely along the bar.

12. The locking bar clamp as set forth in claim 1 wherein the inner clamping jaw is pivotally connected to the toggling linkage mechanism of the locking pliers.

13. The locking bar clamp as set forth in claim 1 wherein the inner and outer clamping jaws each include an elongated flat clamping pad.

14. The locking bar clamp as set forth in claim 1 wherein the inner and outer clamping jaws each include a serrated clamping pad.

15. The locking bar clamp as set forth in claim 1 wherein the inner and outer clamping jaws each include a swivel type clamping pad pivotally connected to the respective inner and outer clamping jaws.

16. The locking bar clamp as set forth in claim 1 wherein the inner and outer clamping jaws each include an elongated curved clamping arm having a clamping pad adapted to engage the material to be clamped while providing clearance between the material and the elongated curved clamping arms.

17. The locking bar clamp as set forth in claim 1 wherein the longitudinal axis of the bar is substantially parallel with the longitudinal axis of the fixed handle of the locking pliers.

18. The locking bar clamp as set forth in claim 1 wherein the adjustable outer clamping jaw may be locked to the bar at any position along the length of the bar.

19. A bar clamp attachment for use with a locking pliers that includes a fixed handle having a longitudinal axis, a movable handle, a toggling linkage mechanism coupled between the fixed and moveable handles for toggling the locking pliers between a first open position and a second clamped position, and an inner clamping jaw connected to the toggling linkage mechanism of the locking pliers such that when the locking pliers are toggled between the open position and the clamped position the inner clamping jaw is caused to move in a direction generally aligned with the longitudinal axis of the fixed handle of the locking pliers, the bar clamp attachment comprising:
a) a bar having a longitudinal axis and including a first end and a second end, the first end being adapted to be detachably connected to the fixed handle of the locking pliers such that the longitudinal axis of the bar is substantially parallel with the longitudinal axis of the fixed handle of the locking pliers; and
b) an adjustable outer clamping jaw slidably connected to the bar for longitudinal movement along the bar, the outer clamping jaw including a disengageable locking mechanism for disengagably locking the outer clamping jaw to the bar.

20. The bar clamp as set forth in claim 19 wherein the bar has a circular cross section and the adjustable outer clamping jaw includes a portion having a circular cross sectional opening through which the outer clamping jaw is slidably connected to the bar.

21. The bar clamp as set forth in claim 19 wherein the bar includes a plurality of detachable bar sections allowing for a variety of bar lengths and the detachable bar sections include threaded ends for interconnecting the bar sections.

22. The bar clamp as set forth in claim 20 wherein the adjustable outer clamping jaw may be rotated to various positions around the longitudinal axis of the bar allowing the outer clamping jaw to be positioned out of line with the inner clamping jaw.

23. The bar clamp as set forth in claim 19 wherein the disengageable locking means for locking the outer clamping jaw in position includes (i) a locking clutch pivotally connected to the outer clamping jaw such that the locking clutch may engage the bar, (ii) spring means for biasing the locking clutch against the bar, and (iii) a lever extending from the locking clutch adapted to allow the user of the tool to disengage the locking clutch thereby allowing the outer clamping jaw to slide freely along the bar.

24. A locking bar clamp comprising:
a) a locking pliers mechanism including a fixed handle having a longitudinal axis, a movable handle, and a toggling linkage mechanism coupled between the fixed and moveable handles for toggling the locking pliers from a first open position to a second clamped position;
b) an elongated bar having a substantially circular cross section and a longitudinal axis and including first and second ends, the first end being detachable and connectable to the fixed handle of the locking pliers such that the bar extends from the fixed handle of the locking pliers with the longitudinal axis of the bar substantially parallel to the longitudinal axis of the fixed handle of the locking pliers;
c) an adjustable outer clamping jaw slidably connected to the bar for longitudinal movement along the bar, the outer clamping jaw including (i) an portion having a circular cross sectional opening through which the outer clamping jaw is slidably connected to the bar (ii) a locking clutch pivotally connected to the outer clamping jaw such that the locking clutch may engage the bar, (iii) a spring arrangement for biasing the locking clutch against the bar, and (iv) a lever extending from the locking clutch adapted to allow the user of the tool to disengage the locking clutch thereby allowing the outer clamping jaw to slide freely along the bar; and
d) an inner clamping jaw connected between the fixed and moveable handles such that when the locking pliers are toggled into the clamped position the inner clamping jaw is caused to move in a direction generally aligned with the longitudinal axis of the fixed handle of the locking pliers and the longitudinal axis of the bar toward the adjustable outer clamping jaw.
